(19) United States
(12) Patent Application Publication
(10) Pub. No.: US 2020/0118421 A1
(43) Pub. Date: Apr. 16, 2020

(54) USER CUSTOMIZABLE PERSONAL REMOTE CONTROL WITH MULTI BEAM INFRARED SYSTEM

(71) Applicant: Patrice Feilles, St Johns (AG)

(72) Inventor: Patrice FEILLES, St. John's (AG)

(21) Appl. No.: 16/626,369

(22) PCT Filed: Jun. 24, 2017
(86) PCT No.: PCT/IB2017/053785

§ 371 Date: Dec. 24, 2019

(51) Int. Cl. G08C 23/04

(52) U.S. Cl. CPC G08C 23/04; G08C 2201/92; G08C 2201/20; G08C 2201/30

(57) ABSTRACT

The apparatus is a multi directional beam infrared remote control handheld device with a fully customizable printable visible slide-in face. A software (hosted on a computer) enables the user to create its own customized graphic design of the slide-in face of the remote and to print it. This software is also used to load the infrared codes emitting sequences (learned from manufacturer remotes or copied from a database). Pressing on any customized part of the slide-in surface of the remote triggers the emission of the corresponding infrared codes in order to control several electrical appliances. An application hosted on a Smartphone can also be used (with a multi directional infrared emitter add-on if necessary) to emulate the physical remote control. Infrared communication can be enhanced by transmitting/receiving pads (powered by USB) connected via mini jack stereo cables and splitters (relaying Infrared signal to all electrical devices in the room).

### TECHNICAL FIELD

A smart home is the place where everything is connected and controlled. In this environment, electronic devices simply talk and live as neighbors.

### BACKGROUND ART

Present-day remote controls are commonly consumer infrared devices which send digitally-coded pulses of infrared radiation to control functions such as power, volume, tuning, temperature set point, fan speed, or other features. Remote controls for these devices are usually small wireless handheld objects with an array of buttons for adjusting various settings such as television channel, track number, and volume. For many devices, the remote control contains all the function controls while the controlled device itself has only a handful of essential primary controls.

The remote control code, and thus the required remote control device, is usually specific to a product line, but there are universal remotes, which emulate the remote control made for most major brand devices.

The main technology used in home remote controls is infrared (IR) light. The signal between a remote control handset and the device it controls consists of pulses of infrared light, which is invisible to the human eye, but can be seen through a digital camera, video camera or a phone camera. The transmitter in the remote control handset sends out a stream of pulses of infrared light when the user presses a button on the handset. A transmitter is often a light emitting diode (LED) which is built into the pointing end of the remote control handset. The infrared light pulses form a pattern unique to that button. The receiver in the device recognizes the pattern and causes the device to respond accordingly.

Touch sensors are input devices and are therefore typically paired with a complementary output device to provide a user with some form of feedback. In modern electronic devices this feedback is typically visual (i.e., a display). In smartphones, for instance, touch sensors are placed directly on top of displays to allow the direct manipulation of on-screen user interfaces. The display provides visual feedback and guides the user through the interaction.

When using a force-sensing touch solution, visual feedback can be implemented by actually printing visual indicators on top of the touch surface itself. For example, treadmills often have force-sensitive buttons behind a flexible membrane. This membrane is printed with a pattern that indicates button location and functionality. Some of these membranes also have raised edges to indicate boundaries between buttons. This adds tactile feedback for the user, and increases the interface's usability. Since the membrane is flexible, the user can transmit forces through the membrane and activate the force-sensitive buttons lying underneath. The membrane provides the user with adequate visual/tactile feedback, rendering a display unnecessary.

### BRIEF SUMMARY OF THE INVENTION

### Overview

The infrared remote control is a handheld device with a fully customizable slide-in face, design, content and complexity of which is fully decided by user and can include branding and pictures (2D and 3D). The infrared beams of the remote are multiple and multi directional to achieve all angles and reach all devices in one room without having to point at the device. When pressing on any part of the slide-in surface of the remote, the user triggers the emission of Infrared codes (than can be customized and sequenced) to control several electrical appliances (that are usually controlled by their own Infrared remote control). The user defines the infrared emitted sequences with a software showing the graphical design created by the user including one to many active zones or buttons (the infrared codes can be learned from the original manufacturers remote or selected from a database). The user configuration is sent to the remote or loaded on corresponding app on a smartphone. The smartphone can be equipped with an add-on multi beam infrared emitter. Infrared transmission can be enhanced for non line of sight devices with infrared transmitting receiving pads connected via stereo cables, customized splitters and a USB power supply. Some users can decide to create a very simple remote (with very few buttons and functions) so the functions needed frequently are obvious and not surrounded with functions that are barely used.

### Characteristics and Advantages of the Invention

When considering as a starting point the existing appliance infrared remote controls and the existing universal and programmable remotes, the innovation provided by the invention resides in four areas:
The infrared beam is multidirectional so the user can still look at the remote when pressing a function (instead of pointing at the devices that he is trying to control).
The user has chosen how many buttons (which shape and size are fully customizable) his remote will have and the function associated with each button can be a timed sequence of several infrared codes destined to multiple appliances. The user can define the permanent interface with infinite possibilities, still the result is loaded to the processor's memory (of the remote) located on the mainboard with clickable buttons. Each group of buttons is assigned functions (sequences of infrared codes) during programming.
The customized remote can alternatively be loaded on a smart phone application and have similar functionality thanks to an infrared add-on plugged into the minijack of the smartphone.
There is also a unique combination of interchangeable modules that achieve the propagation of the infrared codes in areas beyond direct infrared line of sight. Those modules are infrared receiving and transmitting pads, extenders and splitters, that can be combined or extended without changing the current setup.

When considering the control devices associated with home automation systems, the innovation from the invention resides in two areas:
The system is server/controller free: some home automation systems provide remotes that communicate to a main controller processor. When the main processor is unavailable, the home automation solution becomes useless. Based on simple infrared technology, the invention can be a smart backup for advanced home systems (without having to look for all the original appliances remotes).
The system is free from microwave (RF) interference: as the technology used is direct infrared, the solution is not impacted by interference of other device in proximity (not competing with Wifi, Zigbee, Bluetooth or other RF signals).

The user can define the permanent printed interface with infinite possibilities, still the result is loaded to the processor's memory (of the remote) located on the mainboard with clickable buttons. Each group of buttons is assigned functions (sequences of infrared codes) during programming.

This unique combination of affordable existing technology associated with a user defined and modifiable control interface is designed for the user to be in charge at an attractive price of what the remote will do for him as opposed to constantly trying to understand and remember how to use which remote to achieve the intended result.

The control system described in this invention can belong to a person with his (or her) unique needs and taste, not to a device or a room with multiple devices anymore. This invention makes the remote control become personal.

### Exemplary Invention Application Contexts

This remote control system can be used as a customized remote (one per user like family members for example) in lieu of the multiple manufacturers' remotes provided with the appliance.

This remote control system can be used as backup of or in combination with advanced home automation solution/corporate room setup when the server or any other component is not performing as advertised or specified (reason can be defective controller, RF interferences in the Wifi/Zigbee/Bluetooth or other RF frequencies).

This remote control system can also be the remote provided to the housekeeper for basic operations like watching TV while cleaning a room etc. to prevent physically tampering with an advance room setup.

This remote control system can also be a simple remote given to guests (that can be different from the remote used by the owner of the solution)

This remote control system can be used in a corporate environment (in a meeting room, as a three-button wall or desktop mounted branded remote to control the sound volume, turn on/off a ceiling mount projector etc).

This remote control system differs from a universal remote where all imaginable buttons are presents catering for all possible use cases making the use of the remote unfriendly at best an inoperable at worst. This remote is designed for each user (who decides the level of complexity and layout desired)

### BRIEF DESCRIPTION OF THE DRAWINGS

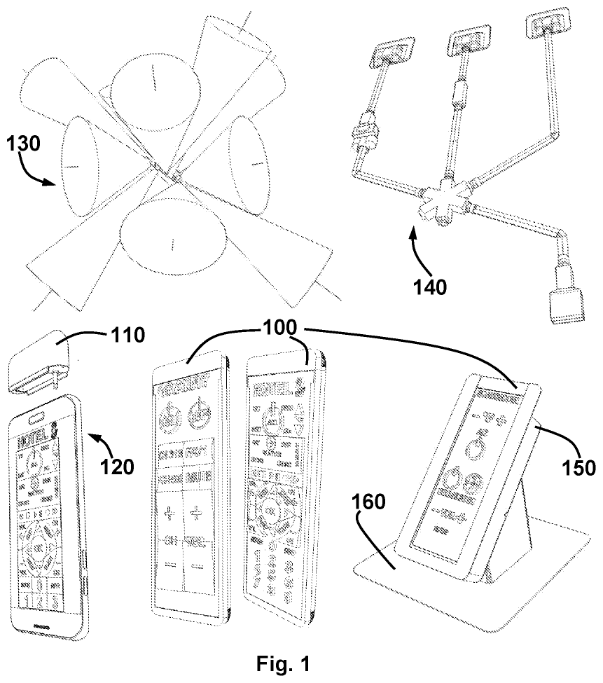

FIG. 1 illustrates the overview of the System and its main components:
100: Remote control assemblies
110: Smartphone add-on assembly
120: Smartphone (supplied by others) with remote control app
130: Multi-directional infrared emission module
140: Infrared enhancement assembly
150: Charging cradle assembly
160: Desktop and wall-mount cradle support

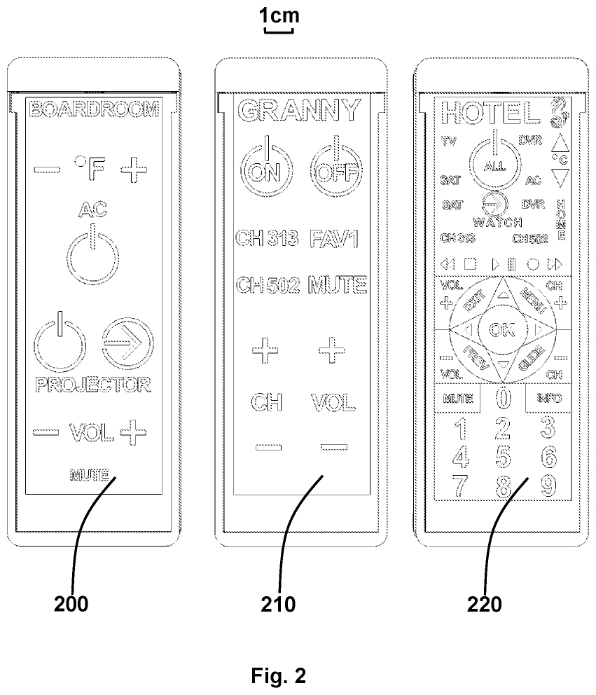

FIG. 2 illustrates examples of 2D faceplates when installed on the remote:
200: Example of remote designed for a meeting room
210: Example of remote designed with very few buttons
220: Example of remote designed for a hotel guest

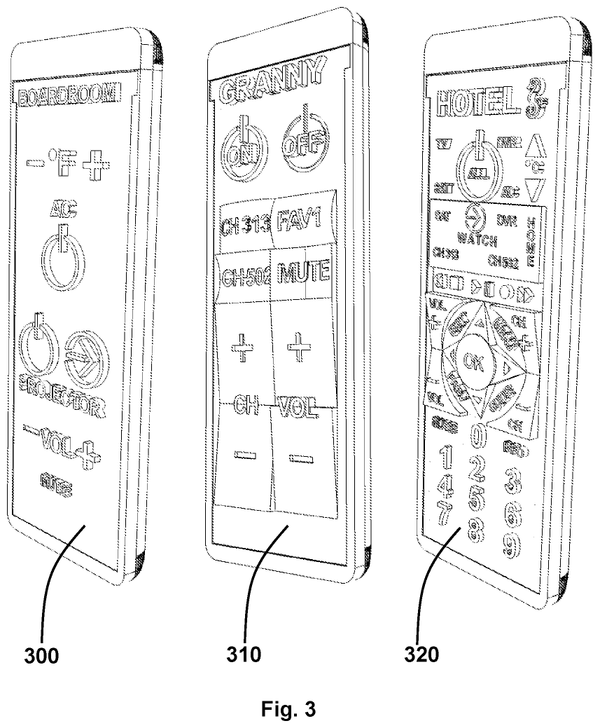

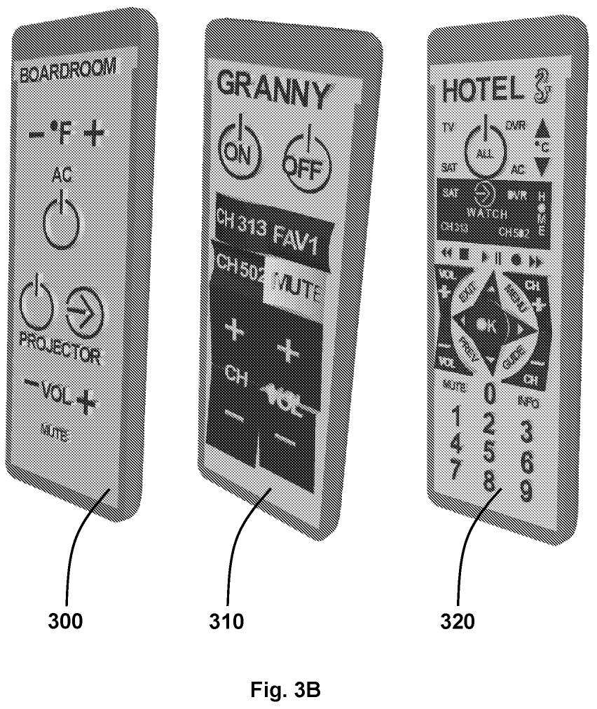

FIG. 3 illustrates examples of 3D faceplates when installed on the remote:
300: Example of remote designed for a meeting room
310: Example of remote designed with very few buttons
320: Example of remote designed for a hotel guest

FIG. 3B illustrates a photographic view of FIG. 3:
300: Example of remote designed for a meeting room
310: Example of remote designed with very few buttons
320: Example of remote designed for a hotel guest

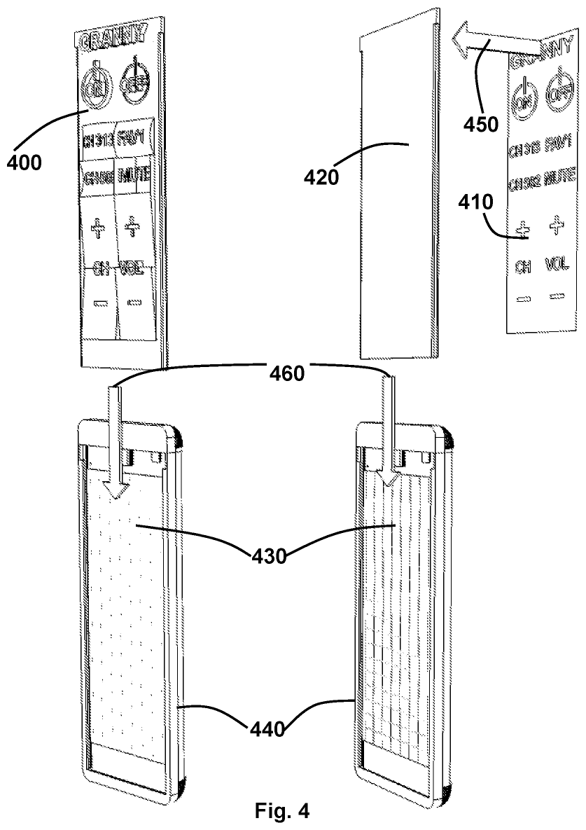

FIG. 4 illustrates the installation method of the 2D and 3D customized faceplates on the remote:
400: 3D sample faceplate
410: 2D printed layout
420: 2D printed sample layout holder to form 2D faceplate
430: Remote control pressure plate
440: Remote control assembly (without faceplate)
450: Direction of installation of 2D printed layout on 2D layout holder
460: Direction of slide-in installation of faceplate on remote control assembly

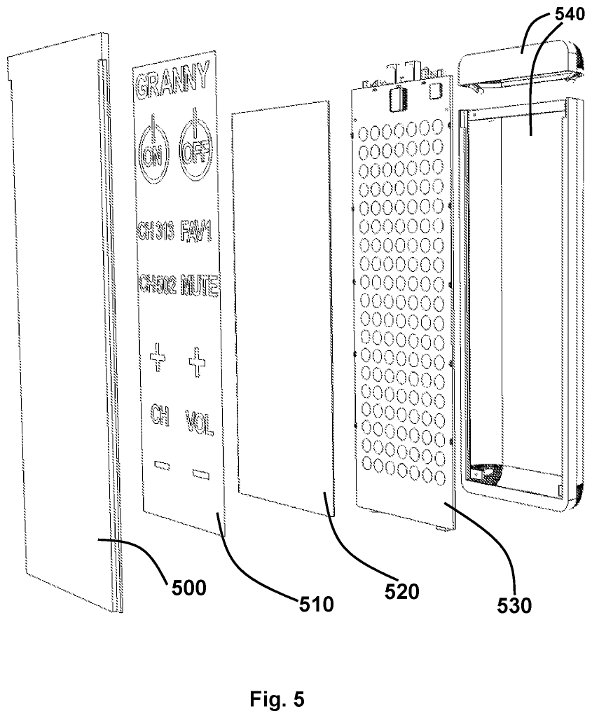

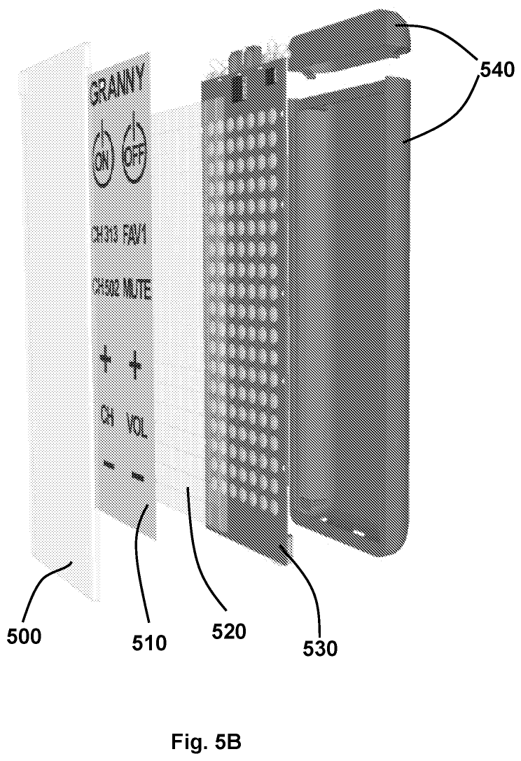

FIG. 5 illustrates an exploded view of the remote control assembly when used with a 2D faceplate:
500: 2D printed layout holder
510: 2D printed layout
520: Pressure plate
530: Main board
540: Enclosure elements

FIG. 5B illustrates a photographic view of FIG. 5:
500: 2D printed layout holder
510: 2D printed layout
520: Pressure plate
530: Main board
540: Enclosure elements

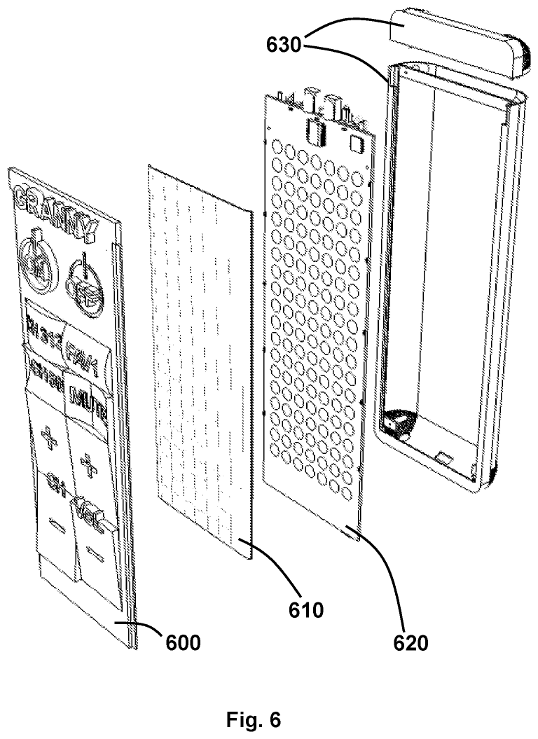

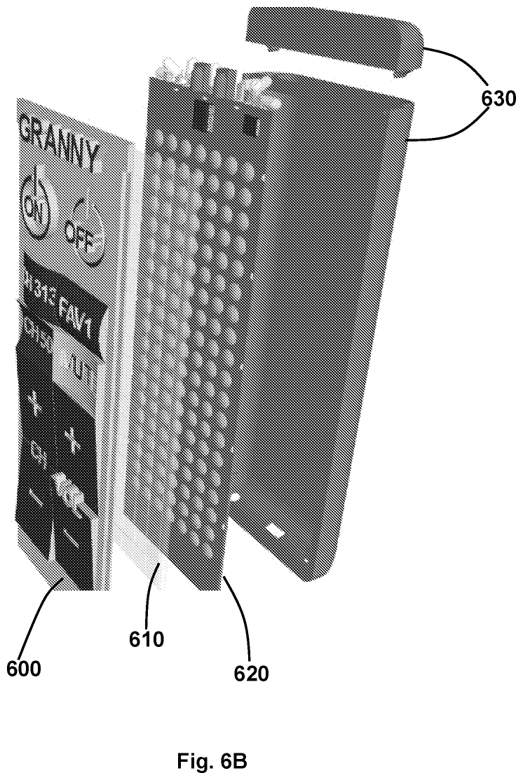

FIG. 6 illustrates an exploded view of the remote control assembly when used with a 3D faceplate:
600: 3D faceplate
610: Pressure plate
620: Main board
630: Enclosure elements

FIG. 6B illustrates a photographic view of FIG. 6:
600: 3D faceplate
610: Pressure plate
620: Main board
630: Enclosure elements

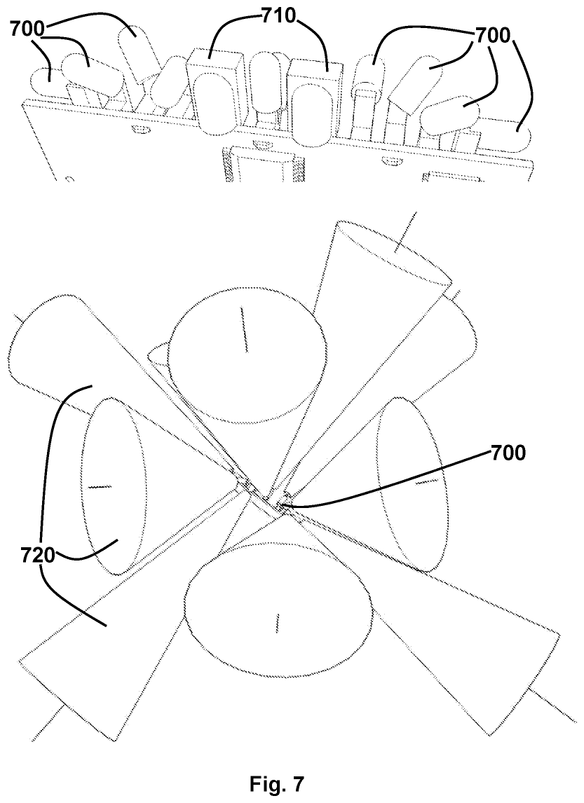

FIG. 7 illustrates the infrared module (multidirectional emission and dual frequency reception):
700: Multidirectional infrared emission LEDs
710: 2-frequency infrared receivers
720: Illustration of multidirectional infrared beams

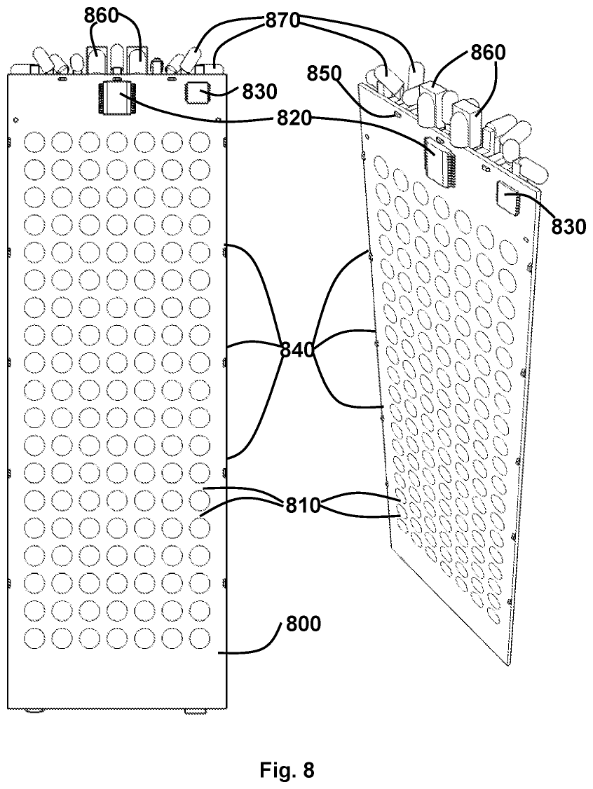

FIG. 8 illustrates the front view of the main board of the remote control assembly:
800: Circuit board
810: Pressure contact closers (buttons)
820: Processor
830: Bluetooth module (configuration and localization of remote)
840: Faceplate illumination LEDs
850: Indicator LEDs
860: 2-frequency infrared receivers
870: Multidirectional infrared emission LEDs

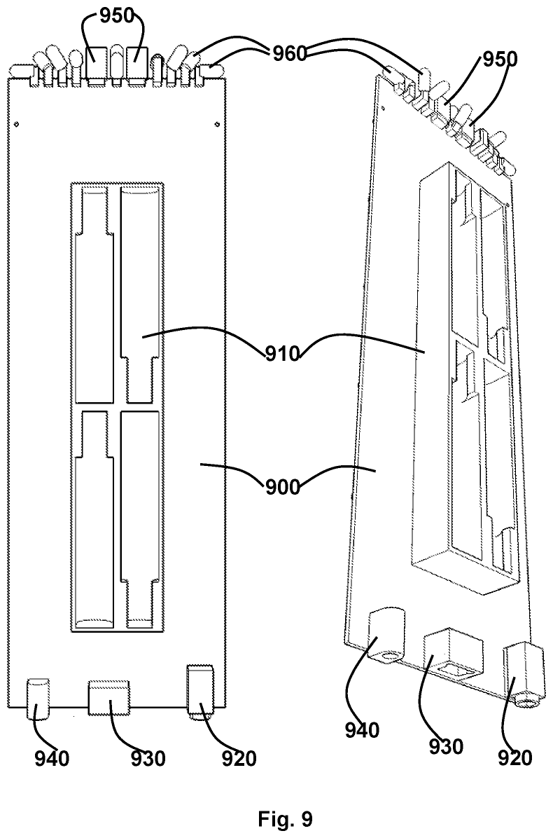

FIG. 9 illustrates the rear view of the main board of the remote control assembly:
900: Circuit board
910: Receptacle for lithium rechargeable batteries
920: Minijack female port
930: Mini USB female connector
940: Lock mechanism female connector
950: 2-frequency infrared receivers
960: Multidirectional infrared emission LEDs

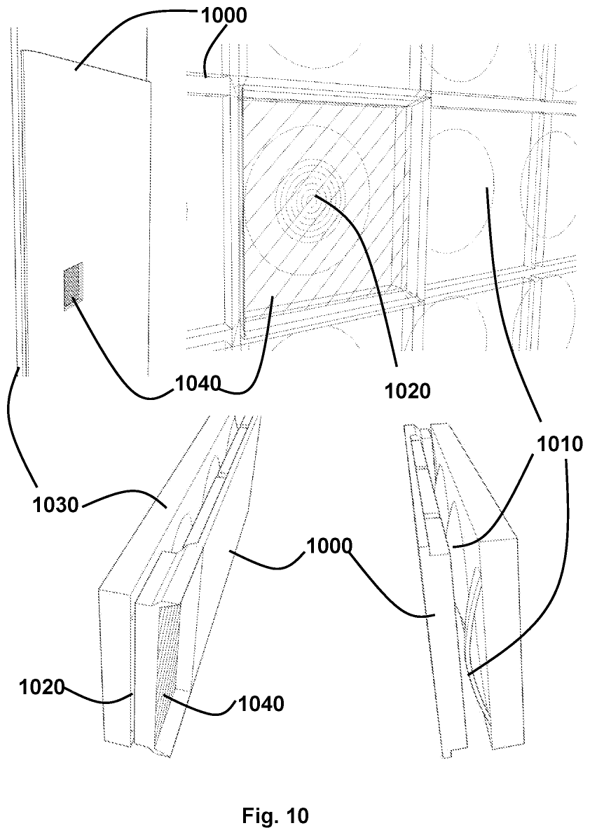

FIG. 10 illustrates the method used by the pressure plate and clickable buttons of the remote control assembly:
1000: Pressure plate
1010: Pressure contact closer—open
1020: Pressure contact closer—close
1030: Circuit board
1040: Depression on pressure plate causing the change of state (open to close) of the pressure contact closer

FIG. 11 illustrates some examples of artwork (graphic design) used for 2D printing and interface programming:
1100: Example of remote designed for a meeting room
1110: Example of remote designed with very few buttons
1120: Example of remote designed for a hotel guest

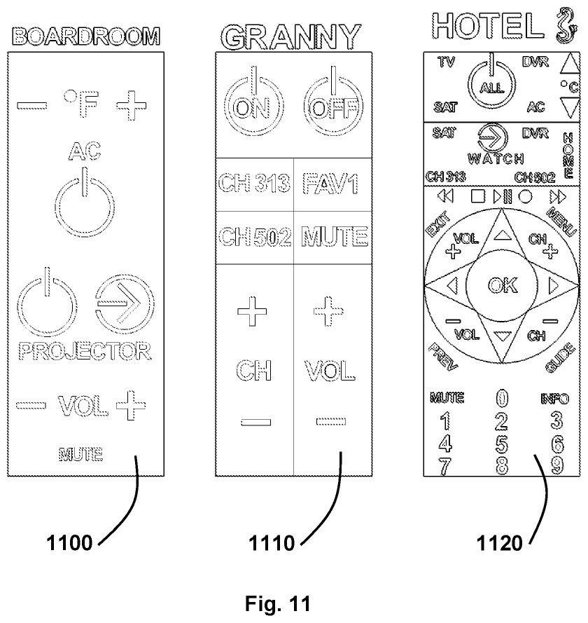

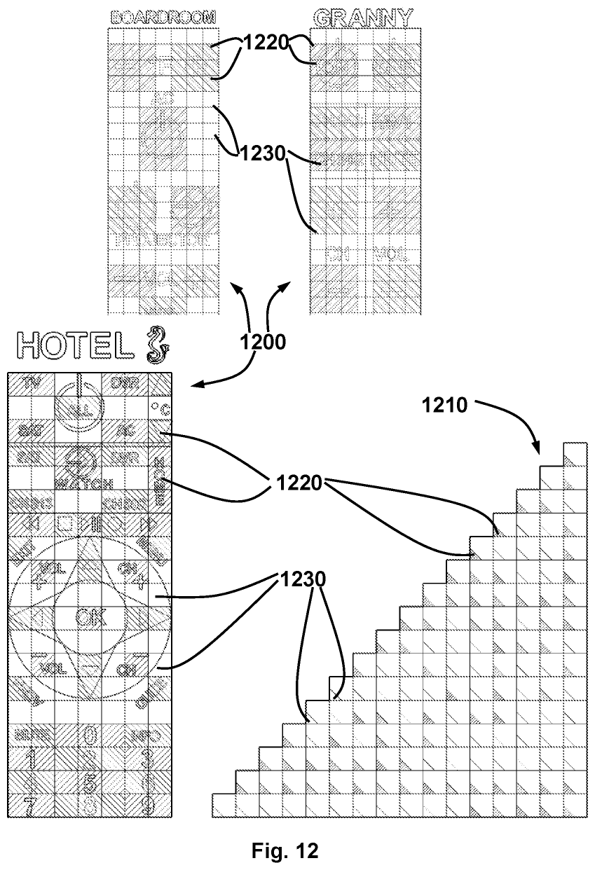

FIG. 12 illustrates the correspondence between the slide-in plate artwork and the clickable buttons defined during programming:
1200: Examples of faceplate design
1210: Processor circuit matrix (each contact is a button on the remote)
1220: Button programmed to trigger a sequence of infrared emission when contact is closed
1230: inactive button (defined during programming)

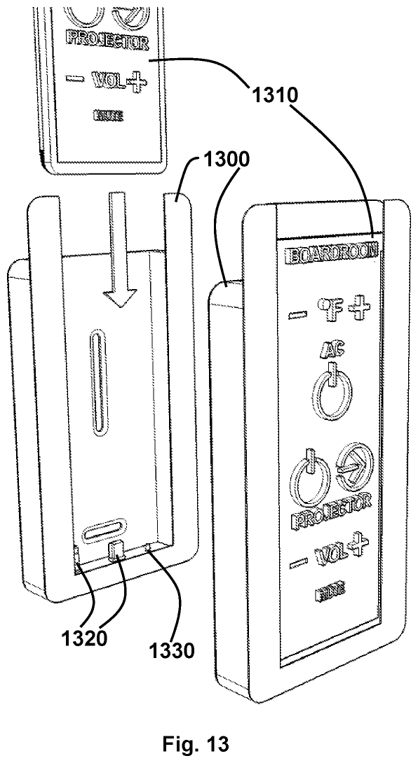

FIG. 13 illustrates the charging cradle assembly that can be used by the remote control assembly:
1300: Charging cradle
1310: Remote control assembly
1320: Charging cradle main board (minijack and micro USB male connectors)
1330: Lock mechanism (screw)

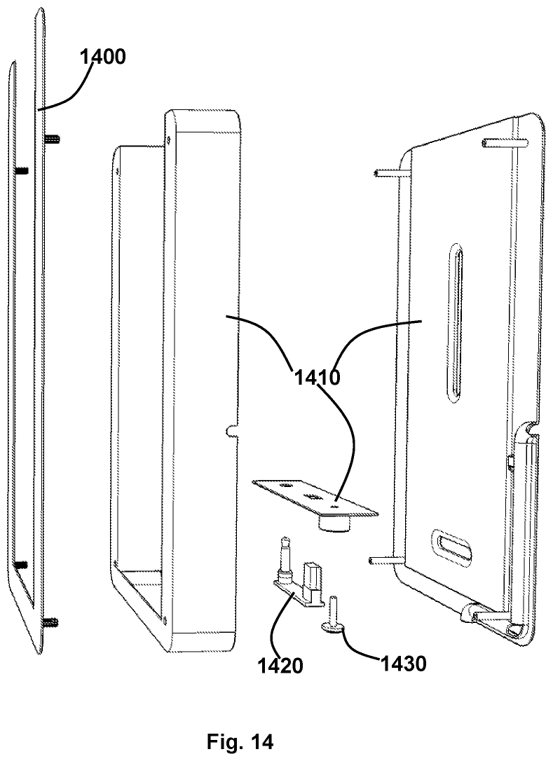

FIG. 14 illustrates an exploded view of the charging cradle assembly:
1400: Front plate
1410: Enclosure elements
1420: Main board (minijack and micro USB male connectors)
1430: Lock mechanism (screw)

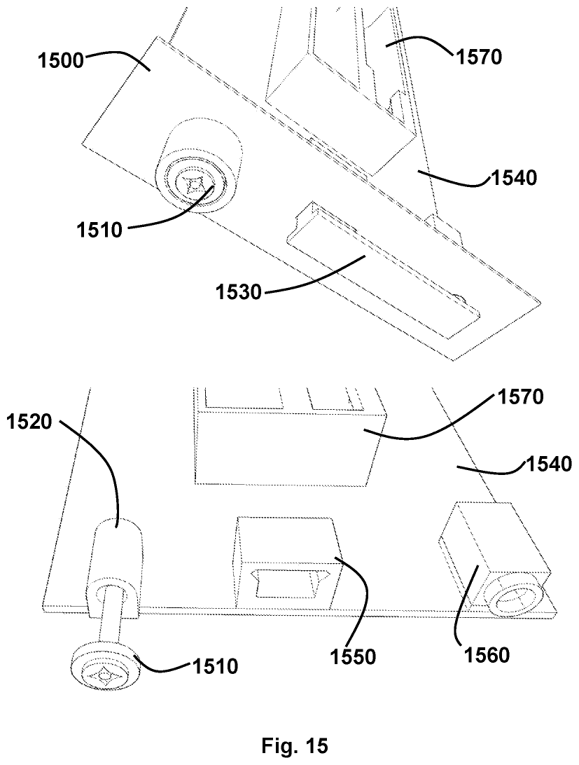

FIG. 15 illustrates the lock mechanism securing the remote control assembly on the charging cradle assembly:
1500: charging cradle enclosure element
1510: Lock mechanism (screw)
1520: Lock mechanism female connector
1530: Charging cradle main board (minijack and micro USB male connectors)
1540: Circuit board
1550: Mini USB female connector
1560: Minijack female port
1570: Receptacle for lithium rechargeable batteries

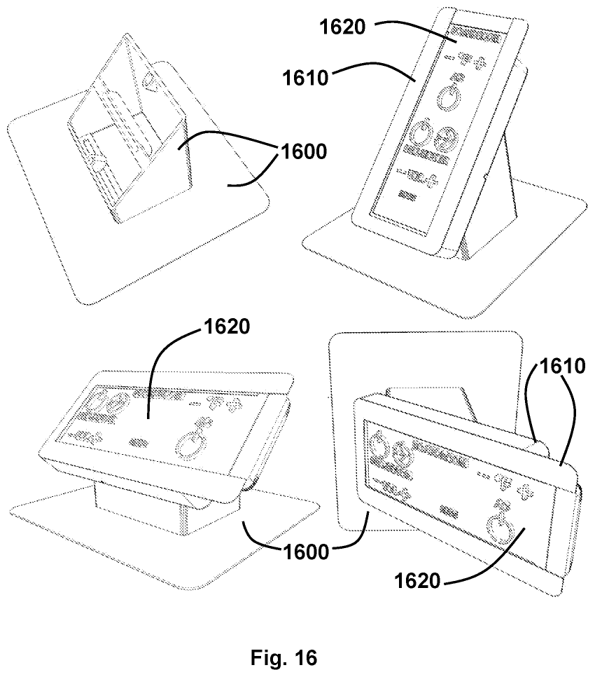

FIG. 16 illustrates the desktop or wall-mount support for the charging cradle assembly:
1600: Desktop or wall mount cradle support
1610: Charging cradle assembly
1620: Remote control assembly

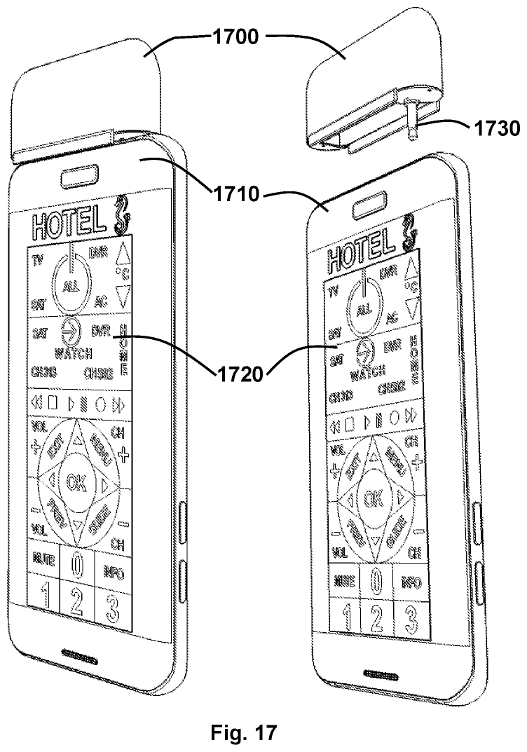

FIG. 17 illustrates the smartphone add-on assembly:
1700: Smartphone add-on assembly
1710: Smartphone (supplied by others)
1720: Smartphone Application
1730: Minijack male port

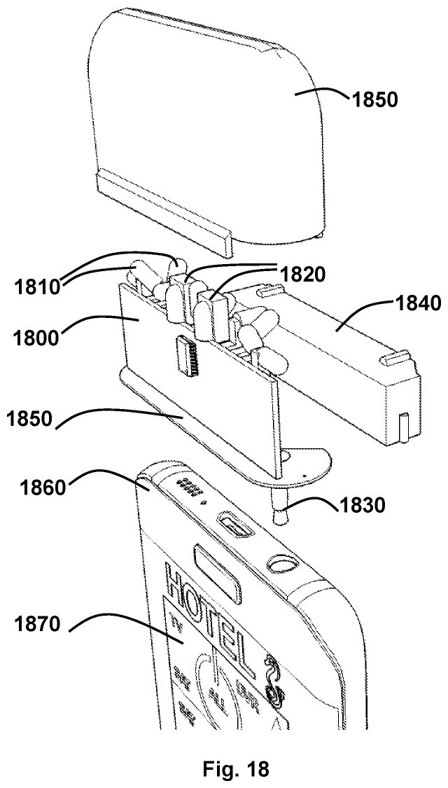

FIG. 18 illustrates an exploded view of the smartphone add-on assembly:
1800: Main board
1810: Multi-directional infrared emission LEDs
1820: 2-frequency infrared receivers
1830: Minijack male port
1840: Receptacle for AAA battery
1850: Enclosure transparent to infrared
1860: Smartphone (supplied by others)
1870: Smartphone Application

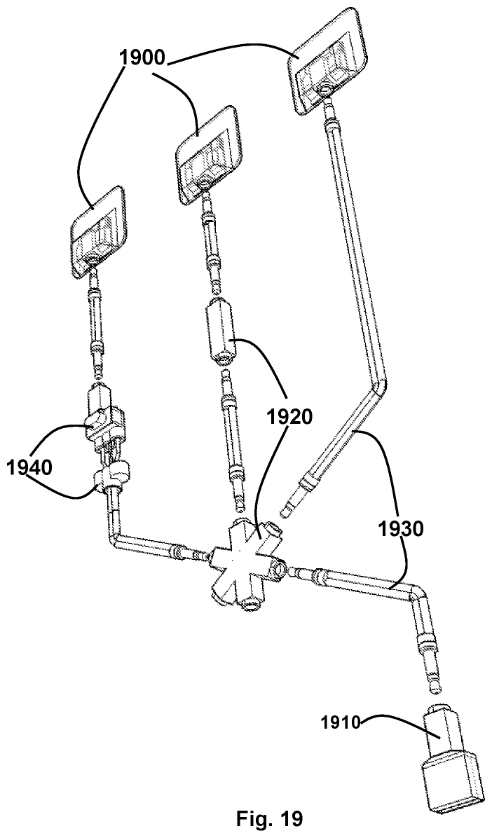

FIG. 19 illustrates the infrared enhancement assembly:
1900: Infrared receiver and emitter pads
1910: USB male connector (power supply and programming interface)
1920: splitter and extender (female minijack)
1930: Minijack stereo patch cord
1940: Snap-on female minijack assembly

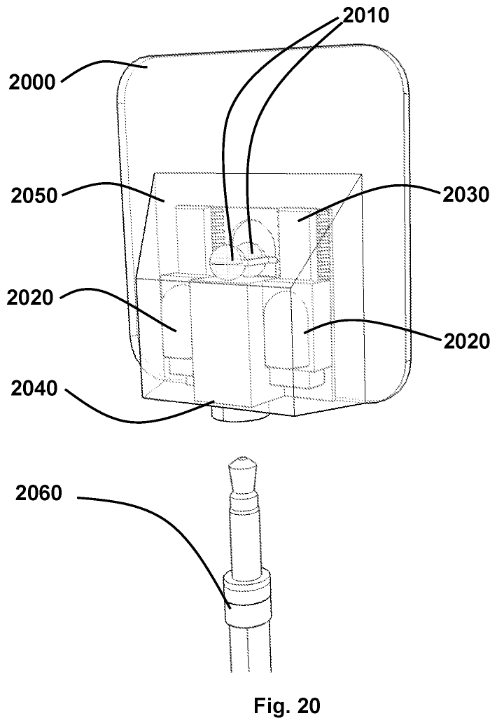

FIG. 20 Illustrates the stick-on infrared receiver and emitter pad, part of the infrared enhancement assembly:
2000: Sticking surface
2010: Infrared LEDs
2020: 2-frequency infrared receivers
2030: Main board
2040: Minijack port (female)
2050: Soft and flexible enclosure transparent to infrared
2060: Minijack stereo patch cord

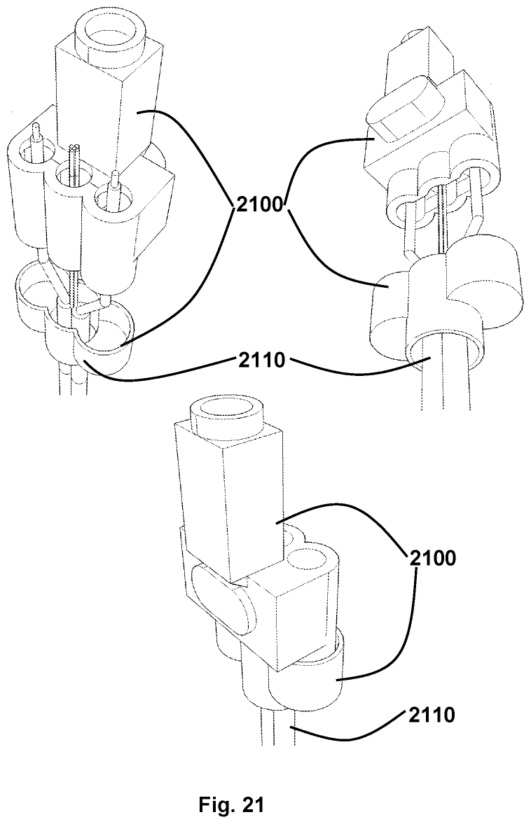

FIG. 21 illustrates the snap-on minijack, part of the infrared enhancement assembly:
2100: Snap-on female minijack assembly
2110: Minijack stereo patch cord

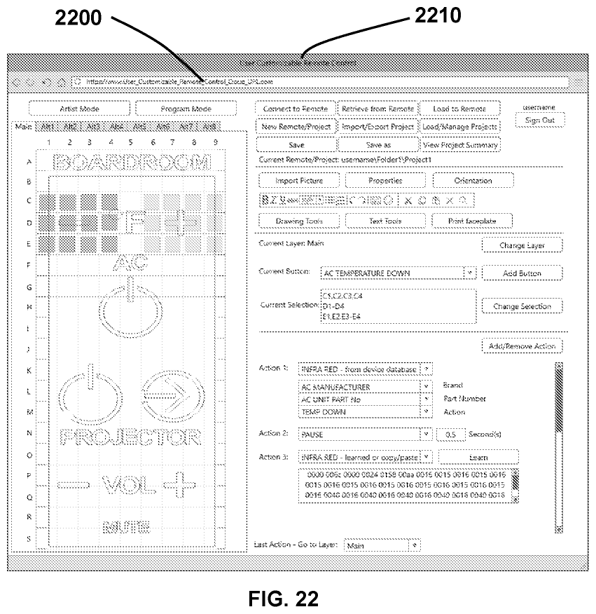

FIG. 22 illustrates the full screen capture view of the programming interface of the remote control assembly:
2200: Browser running the cloud based web app
2210: URL (sample) of cloud based web app

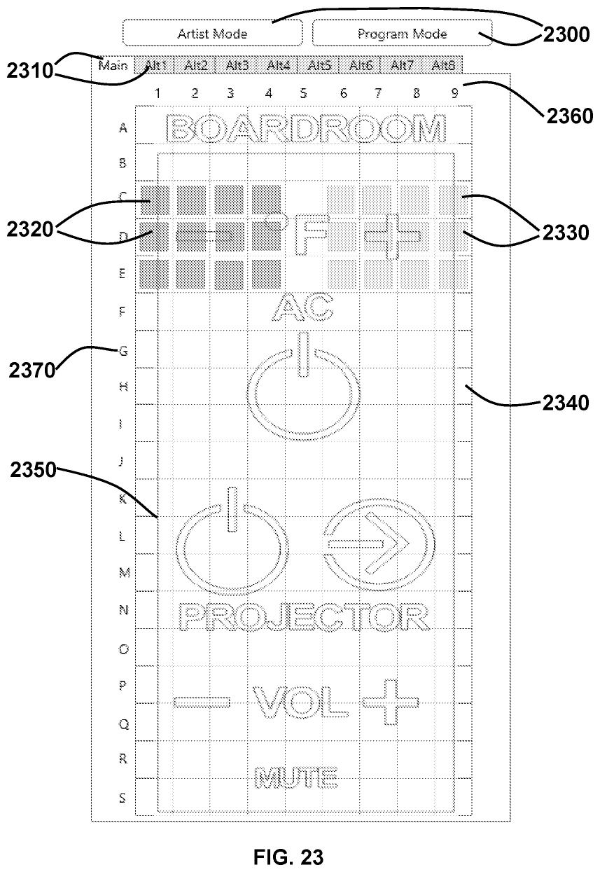

FIG. 23 illustrates the faceplate artwork screen capture view of the programming interface of the remote control assembly:
2300: Switch between artist mode (graphic design applied to all layers) and programming mode
2310: Layers (one button can have a different behavior on each layer)
2320: Buttons programmed to trigger a sequence of infrared emission when contact is closed (assigned to logical button currently being programmed)
2330: Buttons programmed to trigger a sequence of infrared emission when contact is closed (reserved to another logical button)
2340: Buttons with no programming assigned yet for the current layer
2350: Current artwork (graphic design) of the faceplate
2360: column reference of programmable buttons
2370: row reference of programmable buttons

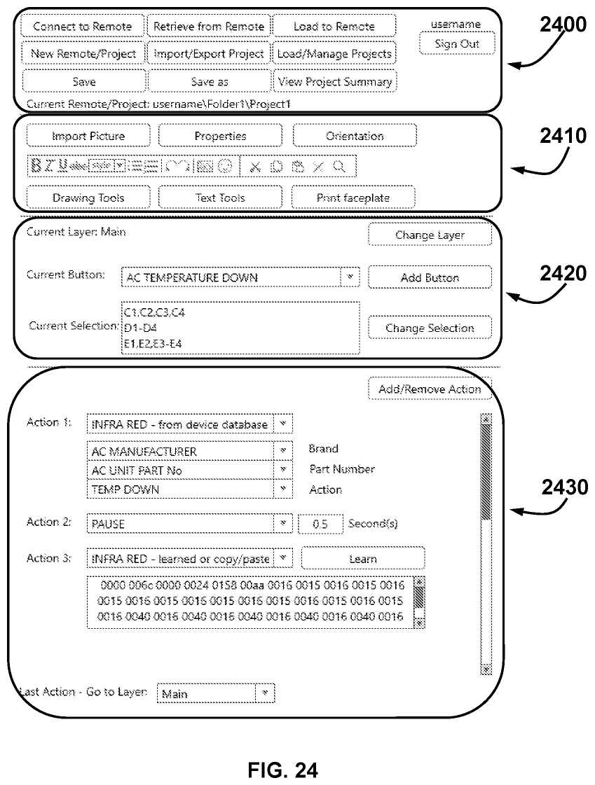

FIG. 24 illustrates the configuration panel screen capture view of the programming interface of the remote control assembly:
2400: Management of current remote control project
2410: Artist mode design tools
2420: Current logical button being programmed
2430: Configuration of actions assigned to logical button currently being programmed

### DESCRIPTION OF THE PRESENTLY PREFERRED EXEMPLARY EMBODIMENTS

While the present invention is susceptible of embodiment in many different forms, there is shown in the drawings and will herein be described in detail preferred embodiments of the invention with the understanding that the present disclosure is to be considered as an exemplification of the principles of the invention and is not intended to limit the broad aspect of the invention to the embodiment illustrated.

### A. Remote Control Assembly

### FIG. 1 (100), FIG. 2, FIGS. 3 and 3B, FIG. 4, FIGS. 5 and 5B, FIGS. 6 and 6B, FIG. 13 (1310), FIG. 16 (1620)

The remote control assembly constitutes the hand held device that is used to control electrical appliances via infrared. The assembly consists of:
A main board with clickable buttons, a multi directional infrared emission module, 2 infrared receptors, a receptacle for rechargeable lithium batteries, a mini USB receptacle (for configuration and charging of rechargeable batteries), a Bluetooth module (for configuration and finding the remote), a speaker (for finding the device and emitting alert signals) illumination LEDs, a minijack port and a lock mechanism.
A pressure spreading plate
A customized slide-in plate
An enclosure
   A.a. Main Board

### FIGS. 5 and 5B (530), FIGS. 6 and 6B (620), FIG. 8, FIG. 9

The main board of the remote control holds all electronic components responsible for all the functions provided by the remote. It also holds the clickable flexible membranes that provide a distinctive indication that the finger triggered the action.

A.a.a. From Clickable Buttons to Clickable Surface

FIG. 10

Each clickable button on the main board is similar in technology as on a regular manufacturer or universal remote. It consists of a flexible membrane made of conductive material and when depressed as the result of a finger or other object applying pressure on the membrane, closes an electrical circuit on the mainboard that triggers the emission on an infrared code or a sequence of infrared codes (via the infrared emission module) as defined during programming of the remote. To achieve the feeling of a clickable surface, the Main board holds a large number of clickable buttons (133 buttons are used in the industrial application described in this document).

A.a.b. Control of Buttons

FIG. 11, FIG. 12, FIG. 22, FIG. 23, FIG. 24

Each button as a unique address. When a button is actioned (circuit closed), the corresponding memorized action is triggered (emission of a sequence of codes via the infrared module). All actions are loaded or retrieved via the programming software when the remoted is connected to a computer via USB or Bluetooth. We will note that Bluetooth connectivity is used only for programming as the devices control action are achieved exclusively with infrared commands (in order to reach the devices infrared receptor without gateway or risk of interference caused by other RF sources).

A.a.c Infrared Emission Module

FIG. 1 (130), FIGS. 5 and 5B (530), FIGS. 6 and 6B (620), FIG. 7, FIG. 8 (870),

FIG. 9 (960)

What makes the infrared module unique (compared to a manufacturer remote) is that it is designed to reach all infrared device receptors within line of sight in the room, suppressing the need to point at a device.

This is achieved without losing range (distance between the remote and the infrared receptor of the devices being controlled) thanks to 10 infrared emitting LEDs spatially distributed.

Note: To reach devices with infrared receptors positioned outside of the line of sight range of the remote (cupboard, audio/visual room room/enclosure), the Infrared helper modules (part of the infrared enhancement assembly) can be used (these infrared helper modules are designed for this purpose).

A.a.d Infrared Receptors

FIGS. 5 and 5B (530), FIGS. 6 and 6B (620), FIG. 7 (710), FIG. 8 (860), FIG. 9 (950)

Two infrared receptors are positioned at the top of the remote. Their role is during the remote programming stage when a manufacturer remote is used to learn the infrared code(s) that a button will emit when pressed. Two of them are present to be compatible with the two main infrared frequencies used by the devices manufacturers.

A.a.e Receptacle for Rechargeable Lithium Batteries

FIG. 9 (910), FIG. 15 (1570)

This receptacle, attached to the main board, provides the power required by the infrared LEDs, infrared receptors, illumination and action LEDs, microprocessors and all other electronic modules present on the main board. The batteries installed in the receptacle received charge when the USB module is plugged in a power source (computer/TV USB port or USB adapter).

A.a.f Mini USB Connector for Charging and Configuration of Buttons Groups

FIG. 9 (930), FIG. 15 (1550)

Positioned on one end of the remote, the role of the mini USB female port (when connected via compatible USB cable) is to provide power to the rechargeable batteries and during the programming phase to transmit all data between microprocessor's memory and computer hosting the programming software.

A.a.g Bluetooth Module (for Configuration and Find My Device Function Only)—not Used for Controlling Appliances.

FIGS. 5 and 5B (530), FIGS. 6 and 6B (620), FIG. 8 (830)

The role of the Bluetooth module installed on the mainboard is twofold (when paired with computer or smartphone hosting the programming software):
during the programming phase to transmit all data between microprocessor's memory and computer hosting the programming software (Bluetooth can thus be used as an alternative to USB cable for that matter).
to have the remote emit an alerting sound (when the “find my remote” is actioned from the computer or smartphone hosting the programming app).

Note: We will note that Bluetooth connectivity is used only for programming (and the “find my remote” function) as the devices control action are achieved exclusively with infrared commands (in order to reach the devices infrared receptor without gateway or risk of interference caused by other RF sources).

A.a.h Speaker (Only Used for Finding My Device and Other Alerting Functions)

The speaker positioned on the main board will emit specific noise instructions in the following scenarios:
The “find my remote” instruction is triggered from the computer or smartphone running the configuration app (and the remote is within Bluetooth range and has been paired at least once).
A reception confirmation of an infrared code (from a manufacturer remote) during the programming stage of the remote.
Low battery warning.

A.a.i Illumination LEDs

FIGS. 5 and 5B (530), FIGS. 6 and 6B (620), FIG. 8 (840, 850)

On the main board can be found some white LEDs which role is to illuminate the remote customized area (slide in plate). When any button is clicked (if the remote is in idle state), the remote is illuminated for a period of time. During that time period, the remote is active and will emit the codes defined during programming when a button (or group of buttons) is pressed.

Also on the main board, some colored LEDs will indicate to the user the fact that the remote is emitting (or receiving—during the programming phase) an infrared code.

The illumination LEDs are positioned on the side of the main board and the light is propagated to the front of the remote (slide in plate) via the pressure plate (made out of transparent light conducive material).

A.a.j Minijack Port

FIG. 9 (920), FIG. 15 (1560)

The female minijack port is positioned on the main board next to the mini USB port. Through that port are transmitted the same infrared codes as the infrared emission module and the electrical power necessary to be used by the infrared enhancement assembly.

When the remote is connected via its minijack port, the multidirectional infrared module can be disabled (this can be useful if several remotes are used in the same room—a fitness center with multiple televisions is a relevant scenario for this feature).

A.a.k Lock Mechanism

FIG. 9 (940), FIG. 15 (1520)

Next to the mini USB port, a lock mechanism is present and consists of a female module with thread (to receive the lock screw). A screw with key type head present on the remote cradle would secure the remote to the cradle.

A.b. Pressure Plate

### FIG. 4 (430), FIGS. 5 and 5B (520), FIGS. 6 and 6B (610), FIG. 10

To achieve the feeling of a clickable surface, the Main board holds a large number of clickable buttons (133 buttons are used in the industrial application described in this document.

The pressure plate is made of flexible and transparent light conducive material. It consists of 133 solid squares. When the square is pressed, 1 button is triggered on the mainboard of the remote control.

A.c. Customized Slide-in Plate

### FIG. 1 (100), FIG. 2, FIGS. 3 and 3B, FIG. 4 (400, 410, 420), FIGS. 5 and 5B (500, 510), FIGS. 6 and 6B (600)

The slide in plate is the plate that is directly in contact with the pressure plate and it is the plate holding all the customized visual information that the user sees during the usage of the remote. The plate can itself be the visual information (2D or 3D color print) of can be manually customized (inserting a 2D printout). The printout is created by the programming interface so the different zones of the remote can be visually recognized during the programming process.

It is made of flexible material so it does not prevent the pressure plate to trigger the click (depression of the flexible membranes on the main board buttons).

### A.d Enclosure

### FIG. 1 (100), FIG. 4 (440), FIGS. 5 and 5B (540), FIGS. 6 and 6B (630)

The enclosure holding in place the main board, and enabling the easy exchange of slide in plates is made of a combination of metal, plastic material and material transparent to infrared. It also enables the occasional replacement of the rechargeable batteries.

### B. Charging Cradle Assembly

### FIG. 1 (150), FIG. 13 (1300, 1320, 1330), FIG. 14, FIG. 16 (1610)

The role of the charging cradle assembly is to hold the remote in specific positions (desktop/countertop, wall mount). While secured, the remote can still be used or configured.

### B.a Cradle

### FIG. 1 (150), FIG. 13 (1300), FIG. 14 (1410), FIG. 15 (1500)

The cradle is designed to match the remote control assembly and it can be secured to a desktop/countertop/wall/electrical outlets with screws. It can also be associated with the Desktop/wall mount cradle support to achieve additional mounting options (angle or larger wall boxes).

B.a.a Main Board

FIG. 13 (1320), FIG. 14 (1420), FIG. 15 (1530)

The main board holds male mini USB connector of a male-male USB-A mini USB cable and a male minijack 3.5 mm connector of a male-male minijack stereo cable. The position of the 2 connectors match the female minijack and USB connectors on the remote control. When the remote is pushed into the cradle, the remote can receive power when the USB-A side is connected to a power source (power adaptor or computer), be configured when the USB-A side is connected to a computer running the configuration software.

B.a.b. Lock Screw

FIG. 13 (1330), FIG. 14 (1430), FIG. 15 (1510)

The lock screw is designed to match the thread present on the remote and operable from a key (screwdriver tip with unusual pattern). When in place, the remote can only be released from the cradle using a screwdriver with the custom tip giving a basic level of anti-theft protection.

B.a.c. Front Plate

FIG. 1 (150), FIG. 13 (1300), FIG. 14 (1400), FIG. 16 (1610)

The front plate is designed to match the size of the remote front to provide a flush finish esthetics when the remote is charging or being used as a desktop mount/wall mount device.

B.a.d. Enclosure Elements

FIG. 1 (150), FIG. 13 (1300), FIG. 14 (1410), FIG. 15 (1500), FIG. 16 (1610) The enclosure elements are present to support and secure the main board, the lock screw and the front plate as well as the remote when connected to the cradle.

### B.b Desktop/Wall Mount Cradle Support

### FIG. 1 (160), FIG. 16 (1600)

This structure provides some support to the remote and remote cradle assembly so it can be used at an angle (different from horizontal of vertical) with all connecting cable hidden. It also hides wall junction boxes when installed over it fastened with screws.

### C. Smartphone Add-on Assembly

### FIG. 1 (110, 120), FIG. 17, FIG. 18

This self-powered (via AAA battery) add-on is designed to be plugged in the minijack female port of any smartphone and provide the same main function as the remote control described in section A. except that the remote control infrared code sequences are triggered from an application (installed on the smartphone) displaying the same layout as the customized slide in face on the main remote. As the remote is taller than most smartphone, some scroll up and down might be required to find the desired button/function.

Another function of this add-on assembly when connected as part of the infrared enhancement assembly is infrared blaster (for example if positioned inside a cabinet hosting equipment).

### C.a Main Board

### FIG. 18 (1800, 1810, 1820, 1830, 1840)

It is a miniature version of the main board of the remote control assembly, but without the section holding the clickable button, the USB charger and the lock screw. It needs a AAA battery to operate.

C.a.a. Infrared Emission Module

FIG. 1 (110, 130), FIG. 7, FIG. 18 (1810)

The infrared module is designed to reach all infrared devices receptors within line of sight in the room, suppressing the need to point at a device.

This is achieved without losing range (distance between the remote and the infrared receptor of the devices being controlled) thanks to 10 infrared emitting LEDs spatially distributed.

Note: To reach devices with infrared receptors positioned outside of the line of sight range of the remote (cupboard, audio/visual room room/enclosure), the Infrared helper modules (part of the infrared enhancement assembly) can be used (these infrared helper modules are designed for this purpose).

C.a.b Infrared Receptors

FIG. 18 (1820)

Two infrared receptors are positioned at the top of the main board. Their role is during the remote programming stage when a manufacturer remote is used to learn the infrared code(s) that a button or group of button(s) will emit when pressed. two of them are present to be compatible with the two main infrared frequencies used by the devices manufacturers.

C.a.c Receptacle for AAA Battery

FIG. 18 (1840)

This receptacle, attached to the main board, provides the power required by the infrared LEDs, infrared receptors, microprocessors and all other electronic modules present on the main board.

C.a.d Minijack Port

FIG. 17 (1730), FIG. 18 (1830)

The male minijack port is positioned on the main board. Through that port the smartphone application communicates to the infrared emission module and infrared receptor.

C.b. Enclosure

### FIG. 1, FIG. 17 (1700), FIG. 18 (1850)

The enclosure has two roles: protect all the components attached to the main board and provide a stable connection when plugged into the smartphone female minijack port.

The top part is made of material transparent to infrared emissions.

### D. Infrared Enhancement Assembly

### FIG. 1 (140), FIG. 19, FIG. 20, FIG. 21

The infrared enhancement assembly is designed to reach the infrared receptors of the devices not situated in direct line of sight of the infrared emission module of the remote control or smartphone add-on accessory.

The assembly is composed of one USB power supply and programming interface, one to many emitter and receiver pads, zero to many splitters, zero to many extenders, one to many patch cord and cable assemblies, zero to many snap-on minijacks.

All minijacks, cables and splitters carry power (fed from USB) to the receiver pad(s), and infrared signal to and from any minijack of the assembly. The infrared signal can come from the USB port (connected to a computer with the application) or any minijack of the assembly (plugged into an existing solution emitting infrared signal).

D.a. Receiver Pad

### FIG. 1 (140), FIG. 19 (1900), FIG. 20

The receiver pad is made of flexible material transparent to infrared and two infrared receptors. The pads do not prevent other infrared signal to go through them and reach the devices infrared receptors.

One side of the pad is adhesive and its large surface of contact is there to guaranty that the pad does not fall easily. Once the pad is in place, it is connected to the rest of the assembly and powered thanks to the pads female minijack connector. The miniature pad can remain on the device when the cable assembly is modified (expansion, maintenance, cleaning of the electric devices setup).

D.b. Emitter Pad

### FIG. 1 (140), FIG. 19 (1900), FIG. 20

The emitter pad is made of flexible material transparent to infrared that will propagate all infrared signal to infrared receptors (of the electric devices being controlled) in close proximity and an infrared LED. The pads do not prevent other infrared signal to go through them and reach the devices infrared receptors.

One side of the pad is adhesive to guaranty close proximity to the devices infrared receptor. The large surface of the pad is there to guaranty that the pad does not fall easily. Once the pad is in place, it is connected to the rest of the assembly thanks to the pads female minijack connector. The miniature pad can remain on the device when the cable assembly is modified (expansion, maintenance, cleaning of the electric devices setup).

D.c. USB Power Supply and Programming Interface

### FIG. 1 (140), FIG. 19 (1910)

The USB-A male port of the assembly is there to provide power (when plugged in to a powered USB port on a device or power adapter). It is also used as programming interface when plugged into a computer hosting the programming software.

D.e. Splitters and Extenders

### FIG. 1 (140), FIG. 19 (1920)

Splitters and extenders guaranty the distribution of the infrared codes to all emitter pads from the source. The number of splitters and extenders required depends on the complexity of the installation.

D.f. Minijack Patch Cord

### FIG. 1 (140), FIG. 19 (1930), FIG. 20 (2060), FIG. 21 (2110)

The components of the assembly are designed to accommodate any standard stereo minijack 3.5 mm male patch cords.

D.g. Minijack Cable Assembly

### FIG. 1 (140), FIG. 19 (1940), FIG. 20 (2060), FIG. 21

The components of the assembly are compatible with complex minijack cable assemblies.

D.g.a. Snap-on Minijack

FIG. 1 (140), FIG. 19 (1940), FIG. 21 (2100)

The snap on minijack is designed to be used on any compatible minijack (3-wire) stereo cable and is useful for complex installation where some of the infrared assembly is going through in wall conduits or when a minijack end is damaged (can be replaced without changing the entire cable).

D.g.b. Cable

The cables used in these assemblies can be of two types:
riser cable designed to be pulled through in wall/floor conduits
equipment/furniture mount exposed cable. The cable can be used with pre-installed minijack connectors or a snap-on minijack can be put in after the cable is in place.

### E. Software (Computer and Mobile App)

E.a. Programming of Remote

### FIG. 22, FIG. 23, FIG. 24

The programming of the remote consists in defining which sequences of infrared codes are emitted when an area of the remote is pressed.

Those instructions are then stored on the embedded memory of the remote.

E.b. Use of Remote

### FIG. 1

The use of the remote can happen at 2 levels.
with the physical remote (configuration stored on the remote)
with the application on a computer or smartphone infrared capable (with or without the smartphone add-on assembly or the infrared enhancement assembly).
   E.c. Find My Remote

The “find my remote” instruction can be triggered from the computer or smartphone running the application (if the remote is within Bluetooth range and has been paired at least once).

### CONCLUSION

The infrared remote control is a handheld device with a fully customizable slide-in face, design, content and complexity of which is fully decided by user and can include branding and pictures (2D and 3D). The infrared beams of the remote are multiple and multi directional to achieve all angles and reach all devices in one room without having to point at the device. When pressing on any part of the slide-in surface of the remote, the user triggers the emission of Infrared codes (than can be customized and sequenced) to control several electrical appliances (that are usually controlled by their own Infrared remote control). The user defines the infrared emitted sequences with a software showing the graphical design created by the user including one to many active zones or buttons (the infrared codes can be learned from the original manufacturers remote or selected from a database). The user configuration is sent to the remote or loaded on corresponding application on a smartphone. The infrared emission capabilities of this smartphone are provided (or can be enhanced) by an add-on multi beam infrared emitter. Infrared transmission can be enhanced for non line of sight devices with infrared transmitting receiving pads connected via stereo cables, customized splitters and a USB power supply. Some users can decide to create a very simple remote (with very few buttons and functions) so the functions needed frequently are obvious and not surrounded with functions that are barely used.

This specific combination of existing technologies used in this application makes this invention unique:
the user can fully decide the design and functionalities of his remote (How it looks like and how complex it is).
in particular, this invention allows to design specific configurations that grant specific, granular access rights to devices for people who are not supposed to operate all the devices, nor have access to all their functionalities.
and this invention can work in combination with an already installed Home automation system and provides essential functionalities when the main Home automation system is down.

1. An infrared remote-control system, for controlling one or more electrical appliances devices, the remote-control system comprising:
a handheld device comprising:
an enclosure;
a main board including:
processing means mounted on the main board;
an infrared module provided with infrared light-emitting diodes (LEDs), controllable by the processing means; and
a matrix of pressure contact closers provided on the main board, for sending control signals to the processing means to trigger an emission of infrared signals by the infrared LEDs;
a customizable slide-in faceplate assembly, removably received in the enclosure, the main board being housed between the enclosure and the customizable slide-in face assembly, the slide-in faceplate comprising zones, each associated to a function of the one or more electrical appliances, the zones overlaying corresponding subsets of the pressure contact closers, such that pressure applied on a given one of the zones actuates a corresponding subset of pressure contact closers and triggers the emission of the infrared signals;
powering means to power the main board; and
a software application for execution on a processor-based device, for designing the zones of the customizable slide-in faceplate assembly; and for programming the processing means with distinct sequences of infrared signals associated to the zones of the customizable slide-in face plate assembly and to functions of the one or more electrical appliances, to control said one or more electric appliance with the handheld device.

2. The infrared remote-control system according to claim 1, wherein the customizable slide-in faceplate assembly comprises a flexible pressure plate in contact with the matrix of pressure contact closers, the flexible pressure plate being positioned behind the zones, and over the main board.

3. The infrared remote-control system according to claim 2, wherein the customizable slide-in faceplate assembly comprises a transparent 2D printed layout holder and a 2D printed layout, the 2D printed layout holder being positioned frontward of the faceplate assembly, the flexible pressure plate being positioned rearward of the faceplate assembly, and the 2D printed layout being positioned between the 2D printed layout holder and the flexible pressure plate.

4. The infrared remote-control assembly according to claim 3, wherein the zones are provided on the 2D printed layout, and wherein the software application includes a graphical user interface allowing a user to draw the zones, import images of remote-control layouts and print the 2D printed layout.

5. The infrared remote-control system according to claim 2, wherein the customizable slide-in faceplate assembly comprises a 3D faceplate, positioned frontward of the faceplate assembly.

6. The infrared remote-control system according to claim 1, wherein the zones include buttons and/or text, indicative of the functions of the one or more electrical appliance.

7. The infrared remote-control system according to claim 1, wherein the processing means include a programmable microprocessor, including a programmable memory for storing instructions associated with the sequences of infrared signals, and a processor for executing instructions stored in the programmable memory, to control the infrared LEDs upon actuation of at least one of the subsets of pressure contact closers.

8. The infrared remote-control system according to claim 7, wherein the processing means further comprise a Bluetooth module and/or a USB module, for interfacing the programmable memory with the software application.

9. The infrared remote-control system according to claim 1, wherein the processing means include one or more 2-frequency infrared receiver(s), for receiving external infrared sequence signals emitted by manufacturer's remote controls of the one or more electrical appliances, said external infrared sequence being usable for programming the handheld device.

10. The infrared remote-control system according to claim 1, wherein the software application includes a database of infrared codes corresponding to functions of the one or more electrical appliances, the software application allowing users to select one or more of the infrared codes and to associate said one or more of the selected codes with zones of the slide-in face plate assembly.

11. The infrared remote-control system according to claim 1, wherein the infrared LEDs are oriented in multiple directions, to emit the infrared signals according to said multiple directions.

12. The infrared remote-control system according to claim 1, wherein the infrared LEDs are spatially distributed at a top end of the handheld device, the infrared module comprising about 10 infrared LEDs.

13. The infrared remote-control system according to claim 1, wherein the main board further comprises a mini-jack port in communication with the processing means, to transmit electric pulses corresponding to the sequences of infrared signals, upon actuation of at least one of the subsets of pressure contact closers.

14. The infrared remote-control system according to claim 1, wherein the infrared module further comprises a modular infrared repeater system, operatively connected to the main board of the handheld device, for repeating the sequences of infrared signals, upon actuation of at least one of the subsets of pressure contact closers

15. The infrared remote-control system according to claim 14, wherein the modular infrared repeater system comprises one or more infrared emitting and receiving pads.

16. The infrared remote-control system according to claim 15, wherein the main board assembly comprises a USB port and wherein the infrared repeater system comprises a USB-minijack connector, the USB-minijack connector having one side connectable to the USB port of the main board, and the other side connectable to the infrared emitter and receiver pads, to power the emitting and receiving pads.

17. The infrared remote-control system according to claim 15, wherein the modular infrared repeater system comprises a plurality of said infrared emitter and receiver pads; a plurality of extenders and splitters, and a plurality of minijack stereo patch cords, the plurality of infrared emitting and receiving pads being connected to the main board via said extenders and splitters, and via said minijack stereo patch cords, thereby creating a network of infrared emitting and receiving pads.

18. The infrared remote-control system according to claim 15, wherein said one or more infrared emitting and receiving pads are transparent to external infrared signals generated outside the infrared remote-control system.

19. (canceled)

20. (canceled)

21. (canceled)

22. (canceled)

23. (canceled)

24. (canceled)
